(19) United States
(12) Patent Application Publication
(10) Pub. No.: US 2017/0129424 A1
(43) Pub. Date: May 11, 2017

(54) EXTERIOR MEMBER FOR WIRE HARNESS AND WIRE HARNESS

(71) Applicant: YAZAKI CORPORATION, Tokyo (JP)

(72) Inventors: Mitsuharu NAGAHASHI, Susono-shi (JP); Masahisa SUGIMOTO, Susono-shi (JP)

(73) Assignee: YAZAKI CORPORATION, Tokyo (JP)

(21) Appl. No.: 15/412,214

(22) Filed: Jan. 23, 2017

Related U.S. Application Data
(63) Continuation of application No. PCT/JP2015/073856, filed on Aug. 25, 2015.

(30) Foreign Application Priority Data
Aug. 25, 2014 (JP) 2014-170074
Sep. 16, 2014 (JP) 2014-187191

(51) Int. Cl. B60R 16/02; H01B 7/00; H02G 3/04

(52) U.S. Cl. CPC B60R 16/0215; H02G 3/0468; H01B 7/0045; B60K 6/22

(57) ABSTRACT

An exterior member for a wire harness, which is formed in a tubular shape, includes a flexible portion which is bendable and a fixed portion which is fixed in a straight shape. The flexible portion is formed by a desired portion in an axial direction of a corrugate tube. The fixed portion is formed by a portion other than the desired portion of the corrugate tube, and a straight pipe which covers an inside or an outside of the portion other than the desired portion.

### CROSS REFERENCE TO RELATED APPLICATIONS

This application is a continuation of PCT application No. PCT/JP2015/073856, which was filed on Aug. 25, 2015 based on Japanese Patent Application (No. 2014-170074) filed on Aug. 25, 2014 and Japanese Patent Application (No. 2014-187191) filed on Sep. 16, 2014, the contents of which are incorporated herein by reference.

### BACKGROUND OF THE INVENTION

<Field of the Invention>

The present invention relates to an exterior member and a wire harness provided with the exterior member.

<Description of Related Art>

A wire harness is used to electrically connect high voltage machines to each other which are loaded in a hybrid car or an electric car.

A wire harness disclosed in Patent Literature 1 is provided with an electrically conductive path and a metallic protection pipe for protecting the electrically conductive path. In order to route the wire harness in a complicated three-dimensional space, first, a straight metallic protection pipe is prepared. Thereafter, an electrically conductive path is inserted into the protection pipe, and the protection pipe is bent with dedicated bending equipment. In this manner, the wire harness is formed being routed along a desired wiring path.

In addition, a wire harness disclosed in Patent Literature 2 is provided with an electrically conductive path, a synthetic resin-made corrugate tube for protecting the electrically conductive path, and a resin-made protector for forming a desired bent portion of the corrugate tube. As understood from the configuration described above, an exterior member is constituted by two kind of resin-made members of the corrugate tube and the protector. The corrugate tube is constituted by a plurality of tubes which are connected by the protector.

Furthermore, a wire harness disclosed in Patent Literature 3 is provided with an electrically conductive path and a synthetic resin-made exterior member for protecting the electrically conductive path. In order to route the wire harness in a complicated three-dimensional space, the exterior member is provided with a bellows pipe-shaped flexible tube portion and a straight tube-shaped straight tube portion. The exterior member is obtained through resin molding with the flexible tube portion and the straight tube portion being connected with each other. Note that, Patent Literature 3 discloses equipment and a method related to the resin molding of the exterior member, in detail.
[Patent Literature 1] JP-A-2004-224156
[Patent Literature 2] JP-A-2010-12868
[Patent Literature 3] JP-A-2013-211963

According to a related art, in an exterior member of the wire harness is a metallic protection pipe, there is a problem that large dedicated equipment is needed so as to bend the exterior member. In addition, according to a related art, in a bent portion of an exterior member of a wire harness is formed using a protector, there is a problem that, in a case where a plurality of bent portions are formed, a plurality of molds for protectors are needed to be provided corresponding to the number of bent portions. Furthermore, according to a related art, in an exterior member of a wire harness has a problem that there is a limitation on the dimensions of the flexible tube portion or the straight tube portion which is attributable to a mold.

### SUMMARY

One or more embodiments provide an exterior member and a wire harness as below.

(1) An exterior member for a wire harness, which is formed in a tubular shape, comprising;

a flexible portion which is bendable; and

a fixed portion which is fixed in a straight shape,

wherein the flexible portion is formed by a desired portion in an axial direction of a corrugate tube, and

wherein the fixed portion is formed by a portion other than the desired portion of the corrugate tube, and a straight pipe which covers an inside or an outside of the portion other than the desired portion.

According to the configuration in (1), the exterior member is obtained by assembling the corrugate tube and the straight pipes. Therefore, it is possible to provide an exterior member which does not need large equipment or a plurality of molds unlike in the related art.

(2) The exterior member for the wire harness according to the above mentioned (1),

wherein the straight pipe covers an outside of the corrugate tube so that the fixed portion is formed.

According to the configuration in (2), the straight pipe covers the outside of the corrugate tube. Therefore, it becomes easy to visually recognize the position of the fixed portion, and thus it is possible to improve the workability.

(3) The exterior member for the wire harness according to the above mentioned (2),

wherein pipe fixing members are respectively provided at both ends of the straight pipes.

According to the configuration in (3), the pipe fixing members are respectively provided corresponding to the positions of the both ends of the straight pipes. Therefore, it is possible to position the fixed portion while preventing displacement of the straight pipes in an insertion direction.

(4) The exterior member for the wire harness according to the above mentioned (3),

wherein the corrugate tube is provided with clamps as the pipe fixing members.

According to the configuration in (4), the corrugate tube is provided with the cramps and the cramps are used to fix the straight pipe. Therefore, the cramps can be used for wire harness routing also, and thus it is possible to suppress the increase in the number of components.

(5) A wire harness comprising;

the exterior member for the wire harness according to any one of the above mentioned (1) to (4); and

an electrically conductive path which is inserted into the exterior member.

According to the configuration in (5), the wire harness includes the exterior member according to any one of the above mentioned (1) to (4). Therefore, it is possible to provide an improved wire harness.

(6) An exterior member for a wire harness, which is formed in a tubular shape, comprising:

a flexible portion which is bendable; and

a fixed portion which is fixed in a straight shape,

wherein the flexible portion is formed by a desired portion in an axial direction of a corrugate tube,

wherein the fixed portion is formed by a fixing portion which is attached and fixed to a portion other than the desired portion of the corrugate tube,

wherein the fixing portion includes a plurality of bellows fitting portions which are arranged along the axial direction and which are externally fitted onto a plurality of bellows concave portions of the corrugate tube, and

wherein each of the plurality of the bellows fitting portions is formed into a bent rib-like shape in which a length in a circumference direction is equal to or greater than half of an outer circumference of one of the bellows concave portions.

According to the configuration in (6), the exterior member is constituted by the corrugate tube and the fixing portion attached to the corrugate tube. Therefore, it is possible to provide an exterior member which does not need large equipment or a plurality of molds unlike in the related art.

(7) The exterior member for the wire harness according to the above mentioned (6),

wherein the fixing portion includes a bent plate portion or a rod-shaped portion which extends along the axial direction and which is integrally formed with the plurality of the bellows fitting portions.

According to the configuration in (7), a member, in which a plurality of bellows fitting portions are integrally formed with each other via a bent plate portion or a rod-shaped portion that extends along the axial direction, also can be used as an effective fixing portion.

(8) The exterior member for the wire harness according to the above mentioned (6) or (7),

wherein each of the plurality of the bellows fitting portions has elasticity and a diameter of each of the plurality of the bellows is formed to be smaller than a diameter of one of the bellows concave portions.

According to the configuration in (8), attachment of the fixing portion to the corrugate tube is performed through external fitting such as press-fitting of the fixing portions onto the bellows concave portions of the corrugate tube using elasticity of the bellows fitting portions. Accordingly, it is possible to attach the fixing portion alone, and thus it is possible to suppress an increase in the number of components.

(9) A wire harness comprising;

the exterior member for the wire harness according to the above mentioned (6) to (8); and

an electrically conductive path which is inserted into the exterior member.

According to the configuration in (9), the wire harness includes the exterior member according to any one of (6) to (8). Therefore, it is possible to provide an improved wire harness.

### Advantageous Effects of Invention

According to the invention, it is possible to provide an exterior member which does not need large equipment or a plurality of molds and of which the dimensions can be easily changed and it is possible to provide a wire harness provided with the exterior member.

### BRIEF DESCRIPTION OF DRAWINGS

FIGS. 1A and 1B are views illustrating a wire harness according to a first embodiment of the invention, where FIG. 1A is a schematic view illustrating a routed state of a high-voltage wire harness and FIG. 1B is a schematic view illustrating a routed state of a wire harness other than that in FIG. 1A.

FIG. 2 is a schematic diagram illustrating the configuration and fixation state of the wire harness in FIG. 1A.

FIG. 3 is a sectional view of a main part in FIG. 2.

FIGS. 4A and 4B are views illustrating a wire harness according to a second embodiment of the invention, where FIG. 4A is a schematic view illustrating a routed state of a high-voltage wire harness and FIG. 4B is a schematic view illustrating a routed state of a wire harness other than that in FIG. 4A.

FIG. 5 is a schematic diagram illustrating the configuration of the wire harness in FIG. 4A.

FIG. 6 is a sectional view of a main part in FIG. 5.

FIG. 7 is a sectional view of a main part in FIG. 5 (including high-voltage electrically conductive path).

FIG. 8 is a view illustrating a modification example of FIG. 5.

FIGS. 9A and 9B are views illustrating an exterior member according to Other example 1 of Embodiment 2, where FIG. 9A is a sectional view and FIG. 9B is a schematic perspective view.

FIGS. 10A to 10C are views illustrating a wire harness according to Other example 2 of Embodiment 2, where FIG. 10A is a schematic view illustrating the configuration of the wire harness, FIG. 10B is a perspective view illustrating fixing portions, and FIG. 10C is a sectional view of a main part in FIG. 10A.

### DESCRIPTION OF EMBODIMENTS

### First Embodiment

A wire harness includes an exterior member and an electrically conductive path that is inserted into the exterior member. The exterior member is formed into a tube-like shape to protect the electrically conductive path. In addition, the exterior member includes flexible portions which are bendable, and fixed portions which are fixed to be straight shapes. The flexible portions are formed by desired portions of a corrugate tube. In addition, the fixed portions are formed by straight pipes which cover the inside or the outside of portions other than the desired portions of the corrugate tube. The corrugate tube and the straight pipe are used being cut into a predetermined length.

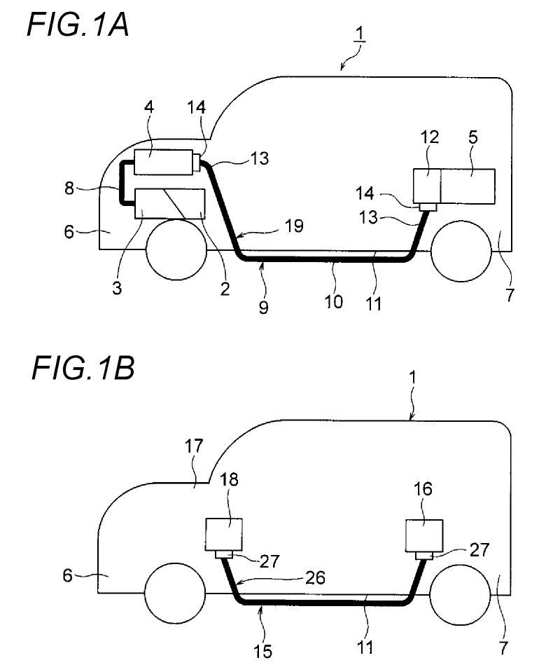

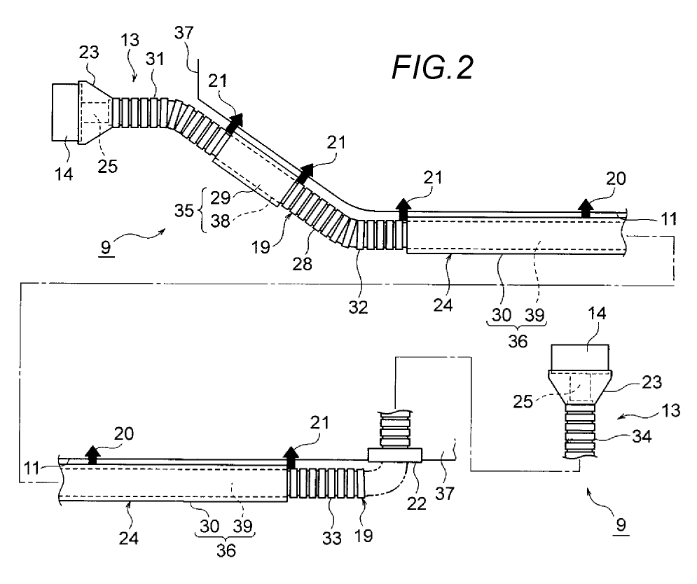

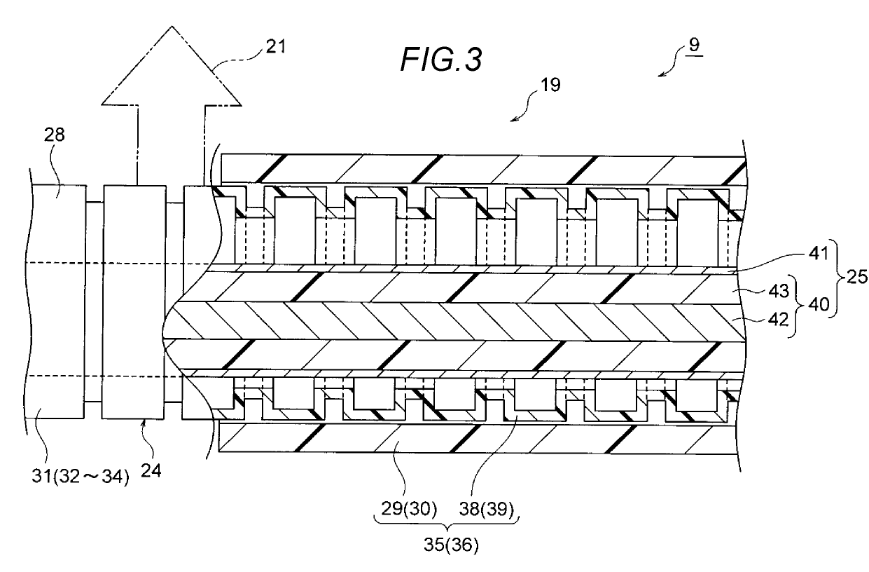

Hereinafter, a wire harness according to a first embodiment will be described with reference to drawings. FIGS. 1A and 1B are views illustrating a wire harness according to the invention, where FIG. 1A is a schematic view illustrating a routed state of a high-voltage wire harness and FIG. 1B is a schematic view illustrating a routed state of a wire harness other than that in FIG. 1A. In addition, FIG. 2 is a schematic diagram illustrating the configuration and fixation state of the wire harness in FIG. 1A and FIG. 3 is a sectional view of a main part in FIG. 2.

In the first embodiment, a case where the invention is applied to a wire harness routed in a hybrid car (or electric car) is used as an example.

As illustrated in FIG. 1A, a hybrid car 1 is a vehicle that is provided with an engine 2 and a motor unit 3 and that is driven using power from the engine 2 and the motor unit 3. Power is supplied from a battery 5 (battery pack) to the motor unit 3 via an inverter unit 4. The engine 2, the motor unit 3, and the inverter unit 4 are mounted into an engine room 6 located near front wheels or the like. In addition, the battery 5 is mounted into an automobile rear portion 7 in which rear wheels or the like are provided. Note that, the battery 5 may be mounted in an automobile cabin which is on the rear side of the engine room 6.

The motor unit 3 and the inverter unit 4 are connected to each other via a wire harness 8 for high voltage (hereinafter, high-voltage wire harness). In addition, the battery 5 and the inverter unit 4 are also connected to each other via a high-voltage wire harness 9. An intermediate portion 10 of the wire harness 9 is routed on a vehicle underfloor portion 11. In addition, the intermediate portion 10 is routed substantially parallel to the vehicle underfloor portion 11. The vehicle underfloor portion 11 is a known body and is a so-called panel member with a through hole formed in a predetermined position. The wire harness 9 is inserted through the through hole in a watertight manner.

The battery 5 includes a junction block 12 and the wire harness 9 and the battery 5 are connected to each other via the junction block 12. Each of harness terminals 13 on a front end side and a rear end side of the wire harness 9 is provided with means for external connection such as a shield connector 14. The junction block 12 is electrically connected with the shield connector 14 on the real end side of the wire harness 9. In addition, the wire harness 9 and the inverter unit 4 are electrically connected to each other via the shield connector 14 on the front end side.

The motor unit 3 is configured to include a motor and a generator. In addition, the inverter unit 4 is configured to include an inverter and a converter. The motor unit 3 is formed as a motor assembly including a shield case. In addition, the inverter unit 4 is also formed as an inverter assembly including a shield case. The battery 5 is a Ni-MH battery or a Li-ion battery and is modulated. Note that, an electrical storage device such as a capacitor also can be used as the battery 5. The battery 5 is not limited as long as the battery 5 can be used for the hybrid car 1 or an electric car.

In FIG. 1B, a wire harness 15 for low voltage (hereinafter, low-voltage wire harness) electrically connects a low-voltage battery 16 in the automobile rear portion 7 of the hybrid car 1 with an auxiliary machine 18 (device) mounted in an automobile front portion 17. The wire harness 15 is routed through the vehicle underfloor portion 11 in the same manner as the wire harness 9 in FIG. 1A. The wire harness 15 may be routed through the automobile cabin side.

As illustrated in FIGS. 1A and 1B, in the hybrid car 1, the high-voltage wire harnesses 8 and 9 and the low-voltage wire harness 15 are routed. Although the invention can be applied to either wire harness, the following description will be made using the wire harness 9 as a representative example.

In FIGS. 1A and 2, the long wire harness 9 which is routed through the vehicle underfloor portion 11 is provided with a harness main body 19 and the shield connectors 14 (means for external connection) which are respectively provided to the both ends of the harness main body 19, that is, the harness terminals 13. In addition, the wire harness 9 is provided with a plurality of clamps 20 and 21 (clamp 21 corresponds to pipe fixing member) for fixing the wire harness 9 to a predetermined position of the vehicle and is provided with water stopping members 22 and 23 (for example, grommet or boot) for restricting moisture intrusion.

In FIG. 2, the harness main body 19 is provided with an exterior member 24 and a high-voltage electrically conductive path 25 which is protected by the exterior member 24 being accommodated therein. Note that, the exterior member 24 may be configured such that the low-voltage wire harness 15 is also protected by the exterior member 24 being accommodated therein. The low-voltage wire harness 15 is configured to include a harness main body 26 and connectors 27 which are respectively provided to the both ends of the harness main body 26 (refer to FIG. 1B).

In FIGS. 2 and 3, the exterior member 24 is configured to include a resin-made corrugate tube 28 and a plurality of resin-made straight pipes 29 and 30. That is, the exterior member 24 is constituted by at least two kinds of tube-shaped members. Note that, the exterior member 24 may include the clamps 20 and 21. The exterior member 24 is provided with flexible portions 31 to 34 which are bendable and fixed portions 35 and 36 which are fixed to be straight shapes.

In the first embodiment, a corrugate tube and straight pipes which are commercially available are used as the corrugate tube 28 and the straight pipes 29 and 30 after being subject to machining. Specifically, a commercially available corrugate tube and commercially available straight pipes, of which the section is circular or oval (flat shape), are used as the corrugate tube 28 and the straight pipes 29 and 30 after being cut into a required length. The corrugate tube 28 is provided with circumferential bellows concave portions and circumferential bellows convex portions and is formed into a bellows pipe-like shape with the bellows concave portions and the bellows convex portions consecutively arranged along an axial direction. The entire corrugate tube 28 is flexible.

Note that, it is needless to say that an in-house molded corrugate tube and in-house molded straight tubes can be used when the size of the commercial product or the like does not fit. In the case of the corrugate tube 28, the required length in the first embodiment corresponds to the entire length of the exterior member 24. It is needless to say that it is possible to flexibly cope with demand for dimensional change or the like by cutting the commercial product in to the required length.

The flexible portions 31 to 34 are set and disposed to portions to be bent. The flexible portions 31 to 34 are formed at desired portions of the corrugate tube 28 since the corrugate tube 28 itself is a flexible member. The flexible portions 31 to 34 are bellows pipe-shaped portions of the exterior member 24. The flexible portions 31 to 34 are formed as portions which are capable of being bent along 360 degrees around an axis. The flexible portions 31 to 34 are disposed and formed according to the shape of a fixation target 37 on which the wire harness 9 is routed. As illustrated in FIG. 2, the fixation target 37 has a curved portion and there is electrical connection near a terminal of the exterior member 24. Therefore, the flexible portions 31 to 34 have a bent portion. The lengths of the flexible portions 31 to 34 are not constant and the flexible portions 31 to 34 are formed corresponding to the fixation target 37. Each of the flexible portions 31 to 34 are bendable at a predetermined angle when the wire harness 9 is packed up, transported, or routed in the vehicle. In addition, each of the flexible portions 31 to 34 are bendable at a large angle.

The fixed portions 35 and 36 are formed by portions other than the desired portions of the corrugate tube 28, that is, by portions 38 and 39 which are portions other than the flexible portions 31 to 34, and the straight pipes 29 and 30 which are attached and fixed to the portions 38 and 39. In addition, the fixed portions 35 and 36 are formed by inserting the straight pipes 29 and 30 onto the outside of the portions 38 and 39. Note that, the straight pipes 29 and 30 may be inserted into the inside of the portions 38 and 39. However, in this case, it is difficult to visually recognize the positions of the fixed portions 35 and 36. In terms of practicability, it is preferable that the straight pipes 29 and 30 are inserted onto the outside of the portions 38 and 39. As the straight pipes 29 and 30, straight pipes, of which the inner diameter is slightly greater than the outer diameter of the corrugate tube 28, are used.

As described above, the shape of the fixed portions 35 and 36 can be fixed. In addition, the fixed portions and 36 can be made resistant to the external force. Specifically, since the fixed portions 35 and 36 are obtained by providing the straight pipes 29 and 30 with a predetermined thickness on the outside of the corrugate tube 28 which is comparatively thin, the fixed portions 35 and 36 are not damaged even when being hit by flying stones at the time of vehicle traveling. It is needless to say that the fixed portions 35 and 36 can ensure a function as the exterior member 24. Note that, the exterior member 24 is light since the exterior member 24 includes the thin corrugate tube 28.

The exterior member 24 according to the first embodiment includes the short fixed portion 35 and the long fixed portion 36. The long fixed portion 36 is routed on the vehicle underfloor portion 11. In addition, although not particularly illustrated in the drawings, in the exterior member 24 according to the first embodiment, the fixed portion is formed with a straight pipe being inserted between the flexible portion 33 and the flexible portion 34. The straight pipe has a predetermined length. In addition, in a case where a bent portion is needed to be formed on the vehicle underfloor portion 11, the above-described long straight pipe 30 may not be used and a straight pipe having an appropriately adjusted length is used.

As understood from FIG. 2, the exterior member 24 is formed such that the flexible portions 31 to 34 and the fixed portions 35 and 36 are alternately arranged.

In FIG. 3, the high-voltage electrically conductive path 25 is an electrically conductive path which is protected by the exterior member 24 being accommodated therein, and is configured to include one or plural high-voltage cables 40 and a shield member 41 that covers the high-voltage cable 40. Note that, such a configuration is merely an example, and the high-voltage electrically conductive path 25 may further include a sheath.

The high-voltage cable 40 is configured to include a conductor 42 and an insulator 43 that covers the conductor 42. The high-voltage cable 40 is formed to have a length required for electrical connection. Since the wire harness 9 electrically connects the inverter unit 4 to the battery 5 (more specifically, junction block 12 in FIG. 1), the high-voltage cable 40 is formed to have a large length.

The conductor 42 is manufactured using copper or a copper alloy, or using aluminum or an aluminum alloy. The conductor 42 may have any of a conductor structure in which element wires are twisted together and a rod-shaped conductor structure with a rectangular or circular section (for example, conductor structure with rectangular single core or round single core) (in this case, wire itself is also formed to have a rod-like shape). The insulator 43, which is formed of an insulative material, is formed through extrusion molding on an outer surface of the conductor 42.

Note that, although a known high-voltage cable is used as the high-voltage cable 40 in the first embodiment, the invention is not limited to this. That is, a high-voltage circuit, which is obtained by providing an insulator in a known bus bar, may be used as the high-voltage cable 40.

The insulator 43 is formed on the outer circumferential surface of the conductor through extrusion molding using thermoplastics material. The insulator 43 is formed as a coating member with a circular section. The insulator 43 is formed to have a predetermined thickness. As the thermoplastics material, known various types of thermoplastics materials can be used. For example, the thermoplastics material is appropriately selected from polymeric materials such as polyvinylchloride resin, polyethylene resin, and polypropylene resin.

The shield member 41 is a member for electromagnetic shielding which collectively covers the high-voltage cable 40, that is, a shield member as a countermeasure for electromagnetic wave. As the shield member 41, a known braid which is formed by braiding a plurality of element wires into a tube-like shape is used. The shield member 41 is formed to have a length which is substantially the same as the entire length of the high-voltage cable 40. An end portion of the shield member 41 is connected to the shield case or the like (not shown) of the inverter unit 4 (refer to FIG. 1) via the shield connector 14 (refer to FIG. 1). Note that, as the shield member 41, for example, conductive metallic foil or a member including the metallic foil may be used as long as the shield member 41 can be used as a countermeasure for electromagnetic wave. In addition, the shield member 41 may be formed into a sheet-like shape so that the shield member 41 is attached being wound.

The clamps 20 and 21 are members for fixing the wire harness 9 to fixation target 37 and each of the clamps 20 and 21 is provided with a portion to be attached to the exterior member 24 and a portion to be fixed to the fixation target 37 with a bolt, a nut, and the like. In the first embodiment, the plurality of clamps 20 are attached to an outer surface of the long straight pipe 30. Meanwhile, unlike the clamps 20, the clamps 21 are attached to the corrugate tube 28 corresponding to the positions of the both ends of the straight pipes 29 and 30. Since the clamps 21 are attached to the above-described positions, the clamps 21 can have a function of preventing displacement of the straight pipes 29 and 30 in the insertion direction and a function of positioning the fixed portions 35 and 36. Since the clamps 21 have the above-described functions, a dedicated component for fixing the corrugate tube 28 and the straight pipes 29 and 30 is not needed.

In the above-described configuration and structure, the wire harness 9 is manufactured as follows. First, the high-voltage electrically conductive path 25 is inserted into the corrugate tube 28. Next, the straight pipes 29 and 30 are inserted onto the corrugate tube 28 and the clamps 20 and 21 are attached to predetermined positions. At last, the shield connectors 14 are provided to respective end portions of the high-voltage electrically conductive path 25 and manufacturing of the wire harness 9 is finished. Note that, water stopping members 22 and 23 such as a grommet or a boot are appropriately attached.

After the wire harness 9 is manufactured as described above, the wire harness 9 is packed up in a predetermined manner and is transported to a vehicle assembling site. In the vehicle assembling site, the wire harness 9 is attached and fixed to the vehicle in such a manner that a portion of the wire harness 9 corresponding to the vehicle underfloor portion 11 is attached first. When a series of work related to the attachment and fixation is finished, the wire harness 9 is routed along a desired path.

As described above with reference to FIGS. 1 to 3, the wire harness 9 is configured to include the resin-made exterior member 24 and the high-voltage electrically conductive path 25 that is inserted into the exterior member 24. The invention is featured by the exterior member 24 and the exterior member 24 is formed by assembling the corrugate tube 28 and the straight pipes 29 and 30. With the corrugate tube 28 in such an exterior member 24, it is possible to form the flexible portions 31 to 34 which are bendable. In addition, with the straight pipes 29 and 30 that cover the outside of the portions 38 and 39 which are not used as the flexible portions 31 to 34, it is possible to form the fixed portions 35 and 36. The shape of the fixed portions 35 and 36 can be fixed.

According to the invention, it is possible to provide the exterior member 24 which does not need large equipment or a plurality of molds unlike in the related art.

In addition, it is possible to easily cope with demand for dimensional change since the exterior member 24 can be obtained by assembling the corrugate tube 28 and the straight pipes 29 and 30 which have been cut into a predetermined length (required length).

Since the wire harness 9 is configured to include the above-described exterior member 24, it is possible to provide an improved wire harness 9.

### Second Embodiment

Hereinafter, a second embodiment will be described with reference to the drawings.

A wire harness includes an exterior member and an electrically conductive path that is inserted into the exterior member. The exterior member is formed into a tube-like shape to protect the electrically conductive path. In addition, the exterior member having such a shape includes flexible portions which are bendable, and fixed portions of which the shape can be fixed. The flexible portions are formed by desired portions of a corrugate tube. In addition, the fixed portions are formed by fixing portions that are attached and fixed to portions other than the desired portions of the corrugate tube.

The fixing portion is formed to have a plurality of bellows fitting portions only or is formed to have a plurality of bellows fitting portions and a bent plate portion or a rod-shaped portion which is integrally formed with the plurality of bellows fitting portions. Each of the plurality of bellows fitting portions is formed into a bent rib-like shape of which the length is equal to or greater than half of the outer circumference of a bellows concave portion of the corrugate tube. Each of the plurality of bellows fitting portions has elasticity and is formed to be smaller than the diameter of the bellows concave portion.

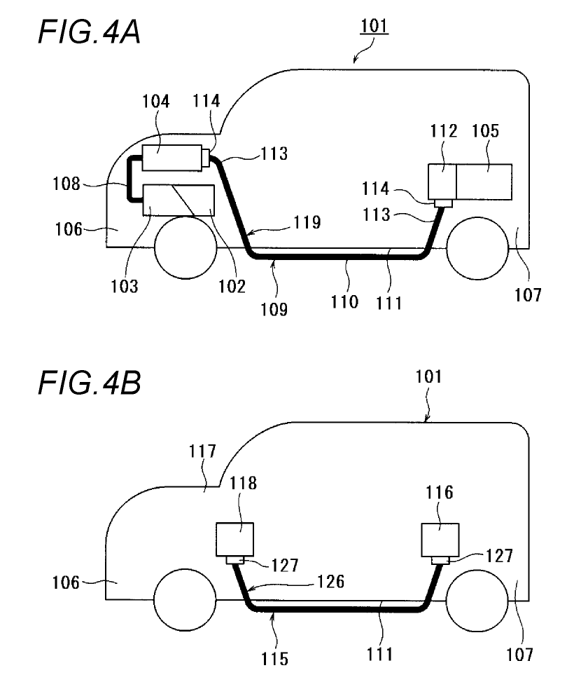

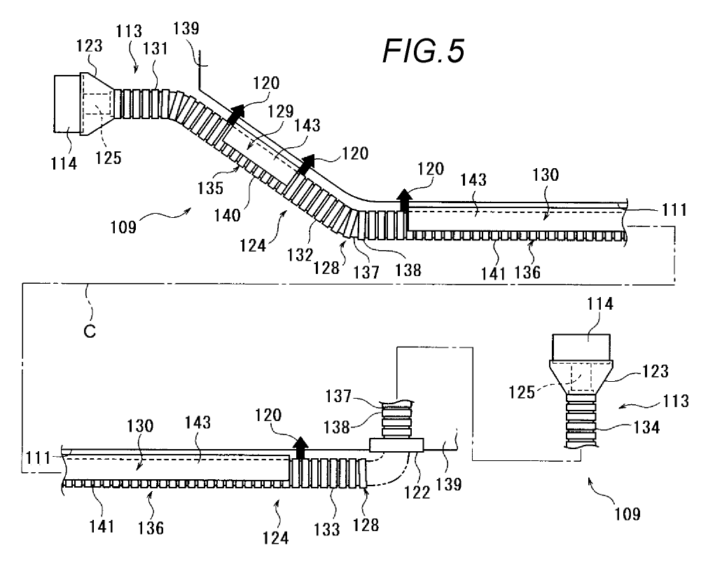

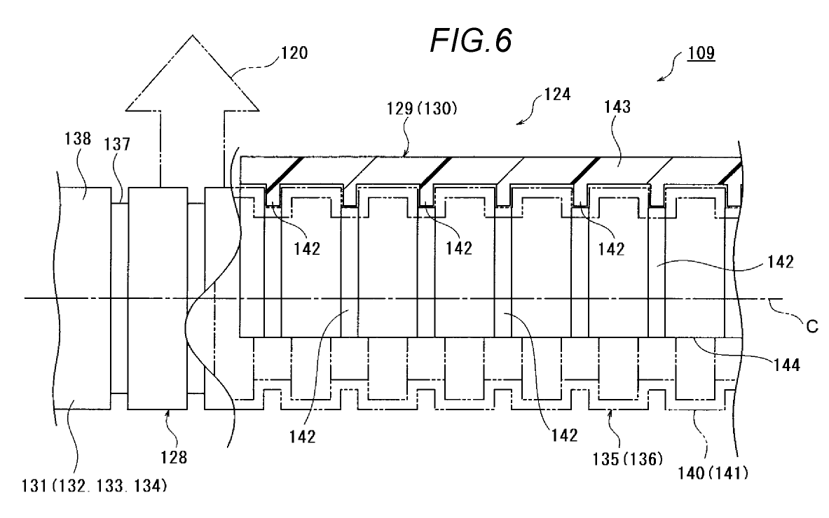

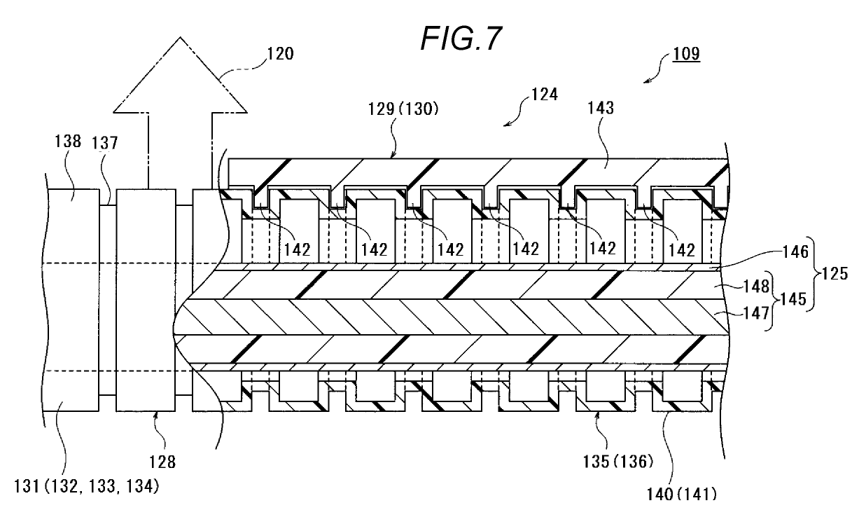

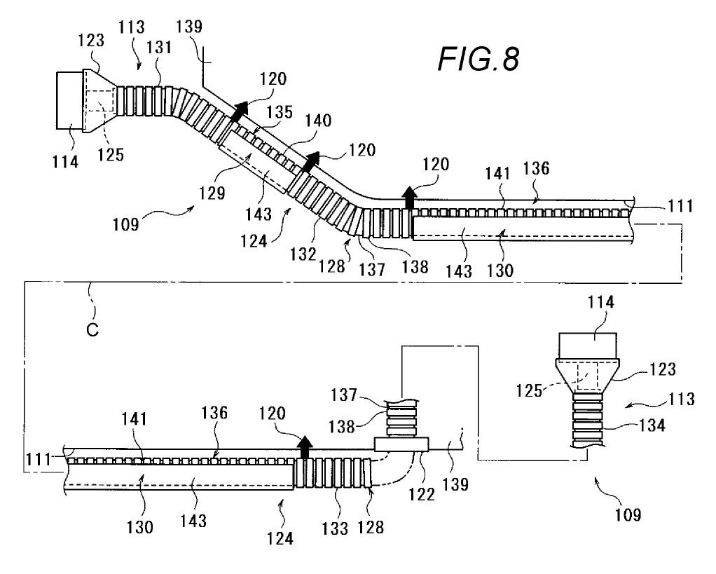

FIGS. 4A and 4B are views illustrating a wire harness according to the second embodiment of the invention, where FIG. 4A is a schematic view illustrating a routed state of a high-voltage wire harness and FIG. 4B is a schematic view illustrating a routed state of a wire harness other than that in FIG. 4A. In addition, FIG. 5 is a schematic diagram illustrating the configuration of the wire harness in FIG. 4A, FIGS. 6 and 7 are sectional views of a main part in FIG. 5, and FIG. 8 is a view illustrating a modification example of FIG. 5.

In the second embodiment, a case where the invention is applied to a wire harness routed in a hybrid car (electric car or the like may be possible) is used as an example.

As illustrated in FIG. 4A, a hybrid car 101 is a vehicle that is provided with an engine 102 and a motor unit 103 and that is driven using power from the engine 102 and the motor unit 103. Power is supplied from a battery 105 (battery pack) to the motor unit 103 via an inverter unit 104. The engine 102, the motor unit 103, and the inverter unit 104 are mounted into an engine room 106 located near front wheels or the like. In addition, the battery 105 is mounted into an automobile rear portion 107 in which rear wheels or the like are provided. Note that, the battery 105 may be mounted in an automobile cabin which is on the rear side of the engine room 106.

The motor unit 103 and the inverter unit 104 are connected to each other via a wire harness 108 for high voltage (hereinafter, high-voltage wire harness). In addition, the battery 105 and the inverter unit 104 are also connected to each other via a high-voltage wire harness 109. An intermediate portion 110 of the wire harness 109 is routed on a vehicle underfloor portion 111. In addition, the intermediate portion 110 is routed substantially parallel to the vehicle underfloor portion 111. The vehicle underfloor portion 111 is a known body and is a so-called panel member with a through hole formed in a predetermined position. The wire harness 109 is inserted through the through hole in a watertight manner.

The battery 105 includes a junction block 112 and the wire harness 109 and the battery 105 are connected to each other via the junction block 112. Each of harness terminals 113 on a front end side and a rear end side of the wire harness 109 is provided with means for external connection such as a shield connector 114. The junction block 112 is electrically connected with the shield connector 114 on the real end side of the wire harness 109. In addition, the wire harness 109 and the inverter unit 104 are electrically connected to each other via the shield connector 114 on the front end side.

The motor unit 103 is configured to include a motor and a generator. In addition, the inverter unit 104 is configured to include an inverter and a converter. The motor unit 103 is formed as a motor assembly including a shield case. In addition, the inverter unit 104 is also formed as an inverter assembly including a shield case. The battery 105 is a Ni-MH battery or a Li-ion battery and is modulated. Note that, an electrical storage device such as a capacitor also can be used as the battery 105. The battery 105 is not limited as long as the battery 105 can be used for the hybrid car 101 or an electric car.

In FIG. 4B, a wire harness 115 for low voltage (hereinafter, low-voltage wire harness) electrically connects a low-voltage battery 116 in the automobile rear portion 107 of the hybrid car 101 with an auxiliary machine 118 (device) mounted in an automobile front portion 117. The wire harness 115 is routed through the vehicle underfloor portion 111 in the same manner as the wire harness 109 in FIG. 4A. The wire harness 115 may be routed through the automobile cabin side.

As illustrated in FIGS. 4A and 4B, in the hybrid car 101, the high-voltage wire harnesses 108 and 109 and the low-voltage wire harness 115 are routed. Although the invention can be applied to either wire harness, the following description will be made using the wire harness 109 as a representative example.

In FIGS. 4A and 5, the long wire harness 109 which is routed through the vehicle underfloor portion 111 is provided with a harness main body 119 and the shield connectors 114 (means for external connection) which are respectively provided to the both ends of the harness main body 119, that is, the harness terminals 113. In addition, the wire harness 109 is provided with a plurality of fixing members 120 (for example, clamp) for fixing the wire harness 109 to a predetermined position of the vehicle and is provided with water stopping members 122 and 123 (for example, grommet or boot) for restricting moisture intrusion.

In FIG. 5, the harness main body 119 (refer to FIG. 4A) is provided with an exterior member 124 and a high-voltage electrically conductive path 125 (electrically conductive path) which is protected by the exterior member 124 being accommodated therein. Note that, the exterior member 124 may be configured such that the low-voltage wire harness 115 is also protected by the exterior member 124 being accommodated therein. The low-voltage wire harness 115 is configured to include a harness main body 126 and connectors 127 which are respectively provided to the both ends of the harness main body 126 (refer to FIG. 4B).

In FIGS. 5 and 6, the exterior member 124 is configured to include a resin-made corrugate tube 128 and a plurality of resin-made fixing portions 129 and 130. Note that, the exterior member 124 may include the clamps 120. The exterior member 124 is provided with flexible portions 131 to 134 which are bendable and fixed portions 135 and 136 which are fixed to be straight shapes.

In the second embodiment, a long corrugate tube with a circular section which has been cut into a required length is used as the corrugate tube 128. Since the corrugate tube 128 is cut into a require length, it is possible to flexibly cope with demand for dimensional change or the like. The corrugate tube 128 is provided with circumferential bellows concave portions 137 and circumferential bellows convex portions 138 and is formed into a bellows pipe-like shape with the bellows concave portions 137 and the bellows convex portions 138 consecutively arranged along an axial direction. The entire corrugate tube 128 is flexible. Note that, the sectional shape of the corrugate tube 128 is not limited to be circular. As described below, even when the sectional shape of the corrugate tube 128 is oval (flat shape), the shapes of the fixing portions 129 and 130 may be changed according to the sectional shape.

The flexible portions 131 to 134 are set and disposed to portions to be bent. The flexible portions 131 to 134 are formed at desired portions of the corrugate tube 128 since the corrugate tube 128 itself is a flexible member. The flexible portions 131 to 134 are bellows pipe-shaped portions of the exterior member 124 to which the fixing portions 129 and 130 are not attached. The flexible portions 131 to 134 are formed as portions which are capable of being bent along 360 degrees around an axis.

The flexible portions 131 to 134 are disposed and formed according to the shape of a fixation target 139 on which the wire harness 109 is routed. As illustrated in FIG. 5, the fixation target 139 has a curved portion and there is electrical connection near a terminal of the exterior member 124. Therefore, the flexible portions 131 to 134 have a bent portion. The lengths of the flexible portions 131 to 134 are not constant and the flexible portions 131 to 134 are formed corresponding to the fixation target 139. Each of the flexible portions 131 to 134 are bendable at a predetermined angle when the wire harness 109 is packed up, transported, or routed in the vehicle. In addition, each of the flexible portions 131 to 134 are bendable at a large angle.

The fixed portions 135 and 136 are formed by portions other than the desired portions of the corrugate tube 128, that is, by portions 140 and 141 which are portions other than the flexible portions 131 to 134, and the fixing portions 129 and 130 which are attached and fixed to the portions 140 and 141. The fixed portions 135 and 136 are formed by externally fitting the fixing portions 129 and 130 onto the portions 140 and 141.

In FIGS. 5 to 7, each of the fixing portions 129 and 130 is formed to have a plurality of bellows fitting portions 142 and a bent plate portion 143 which is formed integrally with the plurality of bellows fitting portions 142 and is formed into a share illustrated in the drawings, for example.

The plurality of bellows fitting portions 142 are arranged along the axial direction. The plurality of bellows fitting portions 142 are formed to be externally fitted onto a plurality of bellows concave portions 137 of the corrugate tube 128. Since the bellows fitting portions 142 are externally fitted onto the bellows concave portions 137, each of the plurality of bellows fitting portions 142 is formed into a bent rib-like shape. Each of the plurality of bellows fitting portions 142 which is formed into a bent rib-like shape is formed to have a length equal to or greater than half of the outer circumference of each of the plurality of bellows concave portions 137 of the corrugate tube 128. In addition, each of the plurality of bellows fitting portions 142 which is formed into a bent rib-like shape is formed to have an inner diameter smaller than the outer diameter of the bellows concave portion 137. Each of the plurality of bellows fitting portions 142 has elasticity.

The bent plate portion 143 is formed into a bent plate-like shape and is integrally formed with the plurality of bellows fitting portions 142 which are arranged along the axial direction so as to cover the plurality of bellows fitting portions 142 from the outside. An end portion of the bent plate portion 143, which is denoted by the reference number 144, is formed corresponding to the position of an end portion of the bellows fitting portion 142. Note that, the end portion 144 may be formed to be shortened to the position of the center line C in FIG. 6 (The end portion 144 may be further shortened. When the end portion 144 is shortened, end portions of the plurality of bellows fitting portions 142 are exposed through the shortened end portion 144 and the end portions function as marks. Therefore, it becomes easy to attach the fixing portions 129 and 130 to the corrugate tube 128.).

Attachment of the fixing portions 129 and 130 to the portions 140 and 141 is performed through external fitting such as press-fitting of the fixing portions 129 and 130 onto the bellows concave portions 137. In addition, the attachment is performed using elasticity of the bellows fitting portions 142. As illustrated in FIG. 5, the fixing portions 129 and 130 are attached and fixed being close to the fixation target 139 (vehicle underfloor portion 111). The fixing portions 129 and 130 are not likely to fall off but attaching and fixing the fixing portions 129 and 130 to be close to the fixation target 139 (vehicle underfloor portion 111) is effective in preventing falling-off of the fixing portions 129 and 130.

The fixing portions 129 and 130 may be attached being apart from the fixation target 139 (vehicle underfloor portion 111) instead of being close to the fixation target 139 (vehicle underfloor portion 111). That is, the fixing portions 129 and 130 may be attached being close to the ground surface as illustrated in FIG. 8. It is needless to say that, when the fixing portions 129 and 130 are attached as illustrated in FIG. 8, the bent plate portion 143 of the long fixing portion 130 effectively functions to prevent damage to the vehicle which is caused by flying stones or the like at the time of vehicle traveling, for example. Note that, only the lone fixing portion 130 may be attached being close to the ground surface.

The exterior member 124 according to the second embodiment includes the short fixed portion 135 and the long fixed portion 136. The long fixed portion 136 is routed on the vehicle underfloor portion 111. In addition, although not particularly illustrated in the drawings, in the exterior member 124 according to the second embodiment, the fixed portion is formed with a fixing portion being inserted between the flexible portion 133 and the flexible portion 134. The fixing portion has a predetermined length. In addition, in a case where a bent portion is needed to be formed on the vehicle underfloor portion 111, the above-described long fixing portion 130 may not be used and a fixing portion having an appropriately adjusted length is used.

As understood from FIG. 5, the exterior member 124 is formed such that the flexible portions 131 to 134 and the fixed portions 135 and 136 are alternately arranged. It can be said that the exterior member 124 is light since the exterior member 124 includes the thin corrugate tube 128 as the base.

In FIG. 7, the high-voltage electrically conductive path 125 is an electrically conductive path which is protected by the exterior member 124 being accommodated therein, and is configured to include one or plural high-voltage cables 145 and a shield member 146 that covers the high-voltage cable 145 (Such a configuration is merely an example, and the high-voltage electrically conductive path 125 may further include a sheath).

The high-voltage cable 145 is configured to include a conductor 147 and an insulator 148 that covers the conductor 147. The high-voltage cable 145 is formed to have a length required for electrical connection. Since the wire harness 109 electrically connects the inverter unit 104 to the battery 105 (more specifically, junction block 112) (refer to FIG. 4), the high-voltage cable 145 is formed to have a large length.

The conductor 147 is manufactured using copper or a copper alloy, or using aluminum or an aluminum alloy. The conductor 147 may have any of a conductor structure in which element wires are twisted together and a rod-shaped conductor structure with a rectangular or circular section (for example, conductor structure with rectangular single core or round single core) (in this case, wire itself is also formed to have a rod-like shape). The insulator 148, which is formed of an insulative material, is formed through extrusion molding on an outer surface of the conductor 147.

Note that, although a known high-voltage cable is used as the high-voltage cable 145 in the second embodiment, the invention is not limited to this. That is, a high-voltage circuit, which is obtained by providing an insulator in a known bus bar, may be used as the high- voltage cable 145.

The insulator 148 is formed on the outer circumferential surface of the conductor through extrusion molding using thermoplastics material. The insulator 148 is formed as a coating member with a circular section. The insulator 148 is formed to have a predetermined thickness. As the thermoplastics material, known various types of thermoplastics materials can be used. For example, the thermoplastics material is appropriately selected from polymeric materials such as polyvinylchloride resin, polyethylene resin, and polypropylene resin.

The shield member 146 is a member for electromagnetic shielding which collectively covers the high-voltage cable 145(a shield member as a countermeasure for electromagnetic wave). As the shield member 146, a known braid which is formed by braiding a plurality of element wires into a tube-like shape is used. The shield member 146 is formed to have a length which is substantially the same as the entire length of the high-voltage cable 145. An end portion of the shield member 146 is connected to the shield case or the like (not shown) of the inverter unit 104 (refer to FIG. 4) via the shield connector 114 (refer to FIG. 4). Note that, as the shield member 146, for example, conductive metallic foil or a member including the metallic foil may be used as long as the shield member 146 can be used as a countermeasure for electromagnetic wave. In addition, the shield member 146 may be formed into a sheet-like shape so that the shield member 146 is attached being wound.

The fixing member 120 is a member for fixing the wire harness 109 to fixation target 139 and the fixing member 120 is provided with a portion to be attached to the exterior member 124 and a portion to be fixed to the fixation target 139 with a bolt, a nut, and the like. In the second embodiment, the fixing members 120 are attached to the corrugate tube 128 corresponding to the positions of the both ends of the fixing portions 129 and 130 (this is merely an example).

In the above-described configuration and structure, the wire harness 109 is manufactured as follows (this is merely an example). First, the high-voltage electrically conductive path 125 is inserted into the corrugate tube 128. Next, the fixing portions 129 and 130 are attached and fixed to the corrugate tube 128 and the fixing members 120 are attached to predetermined positions. At last, the shield connectors 114 are provided to respective end portions of the high-voltage electrically conductive path 125 and manufacturing of the wire harness 109 is finished. Note that, the water stopping members 122 and 123 such as a grommet or a boot are appropriately attached.

After the wire harness 109 is manufactured as described above, the wire harness 109 is packed up in a predetermined manner and is transported to a vehicle assembling site. In the vehicle assembling site, the wire harness 109 is attached and fixed to the vehicle in such a manner that a portion of the wire harness 109 corresponding to the vehicle underfloor portion 111 is attached first. When a series of work related to the attachment and fixation is finished, the wire harness 109 is routed along a desired path.

As described above with reference to FIGS. 4 to 8, the wire harness 109 is configured to include the resin-made exterior member 124 and the high-voltage electrically conductive path 125 that is inserted into the exterior member 124. The invention is featured by the exterior member 124 and the exterior member 124 is constituted by the corrugate tube 128 and the fixing portions 129 and 130 attached to the corrugate tube 128. The corrugate tube 128 includes the flexible portions 131 to 134 which are bendable. In addition, when the fixing portions 129 and 130 are attached to the corrugate tube 128, the portions of the corrugate tube 128 to which the fixing portions 129 and 130 are attached are the fixed portions 135 and 136 which are fixed to be straight shapes. According to the exterior member 124 of the invention, detailed dimensional settings can be made only by setting the dimensions and the number of the fixing portions 129 and 130 according to the necessity. In addition, it is possible to quickly cope with demand for dimensional change.

According to the invention, it is possible to provide the exterior member 124 which does not need large equipment or a plurality of molds unlike in the related art.

Since the wire harness 109 is configured to include the above-described exterior member 124, it is possible to provide an improved wire harness 109.

### Other Example 1 of Second Embodiment

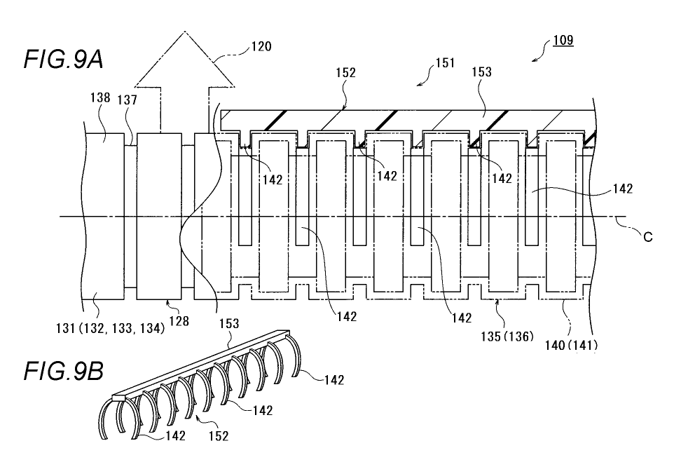

Hereinafter, Other example 1 of the second embodiment will be described with reference to the drawings. FIGS. 9A and 9B are views illustrating an exterior member according to Other example 1, where FIG. 9A is a sectional view and FIG. 9B is a schematic perspective view. Note that, the basically same components as in the above-described embodiments are given the same reference numerals and detailed description thereof will be omitted.

In FIGS. 9A and 9B, an exterior member 151 is configured to include a corrugate tube 128 and a plurality of resin-made fixing portions 152 (only one of these is shown). The exterior member 151 includes flexible portions 131 to 134 which are bendable and fixed portions 135 and 136 which are fixed to be straight shapes. The fixing portion 152 is formed to have a plurality of bellows fitting portions 142 which are arranged along the axial direction and a rod-shaped portion 153 which is formed integrally with the plurality of bellows fitting portions 142 and is formed into a share illustrated in the drawings, for example. Note that, the entire shape is not shown here since the shape is the same as that in FIG. 5 except that the fixing portions 129 and 130 in FIG. 5 are replaced with the fixing portions 152 in FIG. 9.

The plurality of bellows fitting portions 142 are arranged along the axial direction. The plurality of bellows fitting portions 142 are formed to be externally fitted onto a plurality of bellows concave portions 137 of the corrugate tube 128. Since the bellows fitting portions 142 are externally fitted onto the bellows concave portions 137, each of the plurality of bellows fitting portions 142 is formed into a bent rib-like shape. Each of the plurality of bellows fitting portions 142 which is formed into a bent rib-like shape is formed to have a length equal to or greater than half of the outer circumference of each of the plurality of bellows concave portions 137 of the corrugate tube 128. In addition, each of the plurality of bellows fitting portions 142 which is formed into a bent rib-like shape is formed to have an inner diameter smaller than the outer diameter of the bellows concave portion 137. Each of the plurality of bellows fitting portions 142 has elasticity.

The rod-shaped portion 153 is disposed as a rod-shaped portion of the exterior member 151 which extends straight along the axial direction. The rod-shaped portion 153 is formed in such a manner that the rod-shaped portion 153 can ensure rigidity sufficient to fix the shape of the fixed portions 135 and 136. The number of rod-shaped portions 153 is one in this example but the number may be two or more.

As described above with reference to FIG. 9, the exterior member 151 is configured to include the corrugate tube 128 and the fixing portion 152 that is attached to the corrugate tube 128. The corrugate tube 128 becomes the flexible portions 131 to 134 which are bendable and when the fixing portions 152 are attached to the corrugate tube 128, the portions of the corrugate tube 128 to which the fixing portions 152 are attached becomes the fixed portions 135 and 136 of which the shape can be fixed. According to the exterior member 151 in the embodiment of the invention, detailed dimensional settings can be made only by setting the dimensions and the number of the fixing portions 152 according to the necessity. In addition, it is possible to quickly cope with demand for dimensional change.

According to the invention, it is possible to provide the exterior member 151 which does not need large equipment or a plurality of molds unlike in the related art.

Since the wire harness is configured to include the above-described exterior member 151, it is possible to provide an improved wire harness.

### Other Example 2 of Second Embodiment

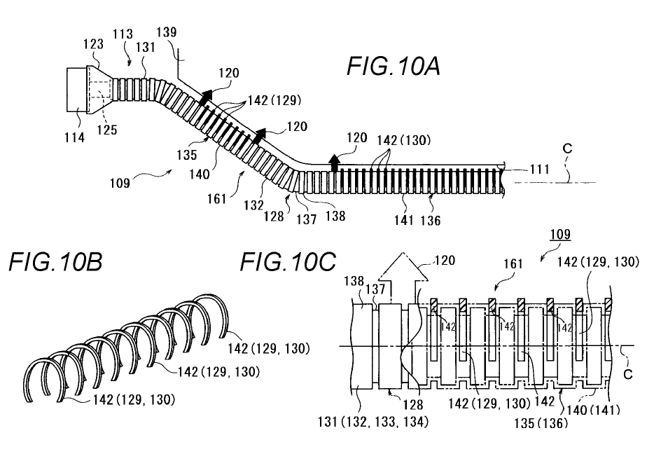

Hereinafter, Other example 2 of the second embodiment will be described with reference to the drawings. FIGS. 10A to 10C are views illustrating a wire harness according to Other example 2, where FIG. 10A is a schematic view illustrating the configuration of the wire harness, FIG. 10B is a perspective view illustrating fixing portions, and FIG. 10C is a sectional view of a main part in FIG. 10A. Note that, the basically same components as in the above-described embodiments are given the same reference numerals and detailed description thereof will be omitted.

In FIGS. 10A to 10C, the long wire harness 109 is provided with a harness main body 119 (refer to FIG. 4A) and the shield connectors 114 (means for external connection) which are respectively provided to the both ends of the harness main body 119, that is, the harness terminals 113. In addition, the wire harness 109 is provided with a plurality of fixing members 120 (for example, clamp) for fixing the wire harness 109 to a predetermined position of the vehicle and is provided with water stopping member 122 or the like for restricting moisture intrusion.

The harness main body 119 (refer to FIG. 4A) is provided with an exterior member 161 and a high-voltage electrically conductive path 125 (electrically conductive path) which is protected by the exterior member 161 being accommodated therein. Note that, the exterior member 161 may be configured such that the low-voltage wire harness 115 (refer to FIG. 4B) is also protected by the exterior member 161 being accommodated therein.

The exterior member 161 is configured to include a corrugate tube 128 and a plurality of resin-made fixing portions 129 and 130. The exterior member 161 includes flexible portions 131 to 134 (refer to FIG. 5 for 133 and 134) which are bendable and fixed portions 135 and 136 of which the shape can be fixed. The fixing portion 129 forms the fixed portion 135 and the fixing portion 130 forms the fixed portion 136. Each of the fixing portions 129 and 130 is includes a plurality of bellows fitting portions 142 only which are arranged along the axial direction and is formed into a share illustrated in the drawings.

It can be said that the plurality of bellows fitting portions 142 are the fixing portions 129 and 130 and the plurality of bellows fitting portions 142 are members which are externally fitted onto a plurality of bellows concave portions 137 of the corrugate tube 128 one by one. Each of the plurality of bellows fitting portions 142 is formed into a bent rib-like shape. Each of the plurality of bellows fitting portions 142 which is formed into a bent rib-like shape is formed to have a length equal to or greater than half of the outer circumference of each of the plurality of bellows concave portions 137 of the corrugate tube 128. In addition, each of the plurality of bellows fitting portions 142 which is formed into a bent rib-like shape is formed to have an inner diameter smaller than the outer diameter of the bellows concave portion 137. Each of the plurality of bellows fitting portions 142 has elasticity.

As described above with reference to FIGS. 10A to 10C, the exterior member 161 is configured to include the corrugate tube 128 and the fixing portions 129 and 130 (plurality of bellows fitting portions 142) that are attached to the corrugate tube 128. The corrugate tube 128 becomes the flexible portions 131 to 134 (refer to FIG. 5 for 133 and 134) which are bendable and when the plurality of bellows fitting portions 142 are attached to the corrugate tube 128, the portions of the corrugate tube 128 to which the plurality of bellows fitting portions 142 are attached becomes the fixed portions 135 and 136 which are fixed to be straight shapes. According to the exterior member 161 of the invention, detailed dimensional settings can be made only by setting the number of the bellows fitting portions 142 according to the necessity. In addition, it is possible to quickly cope with demand for dimensional change.

According to the invention, it is possible to provide the exterior member 161 which does not need large equipment or a plurality of molds unlike in the related art.

Since the wire harness 109 is configured to include the above-described exterior member 161, it is possible to provide an improved wire harness 109.

Here, features of the above described embodiments of an exterior member for a wire harness and a wire harness according to the invention will be respectively summarized in following [1] to [9].

[1] A tube-shaped exterior member (24) for a wire harness, comprising;

a flexible portion (31 to 34) which is bendable; and

a fixed portion (35 and 36) which is fixed in a straight shape,

wherein the flexible portion is formed by a desired portion in an axial direction of a corrugate tube (28), and

wherein the fixed portion is formed by a portion other than the desired portion of the corrugate tube, and a straight pipe (29 and 30) which covers an inside or an outside of the portion other than the desired portion.

[2] The exterior member for a wire harness according to [1],

wherein the straight pipe covers an outside of the corrugate tube so that the fixed portion is formed.

[3] The exterior member for a wire harness according to [2],

wherein pipe fixing members (21) are respectively provided with both ends of the straight pipes.

[4] The exterior member for a wire harness according to [3],

wherein the corrugate tube is provided with clamps as the pipe fixing members.

[5] A wire harness comprising;

the exterior member for a wire harness according to any one of [1] to [4]; and

an electrically conductive path (high-voltage electrically conductive path 25) which is inserted into the exterior member.

[6] A tube-shaped exterior member (124) for a wire harness, which is formed in a tubular shape, compring:

a flexible portion (131 to 134) which is bendable; and

a fixed portion (135 and 136) which is fixed in a straight shape,

wherein the flexible portion is formed by a desired portion in an axial direction of a corrugate tube (128),

wherein the fixed portion is formed by a fixing portion (129 and 130) that are attached and fixed to a portion other than the desired portion of the corrugate tube,

wherein the fixing portion includes a plurality of bellows fitting portions (142) that are arranged along the axial direction and are externally fitted onto a plurality of bellows concave portions (137) of the corrugate tube, and

the bellows fitting portion is formed into a bent rib-like shape of which the length in a circumference direction is equal to or greater than half of the outer circumference of the bellows concave portion.

[7] The exterior member for a wire harness according to [6],

in which the fixing portion includes a bent plate portion (143) or a rod-shaped portion (153) that extends along the axial direction and is integrally formed with the plurality of bellows fitting portions.

[8] The exterior member for a wire harness according to [6] or [7],

in which each of the plurality of bellows fitting portions has elasticity and is formed to be smaller than the diameter of the bellows concave portion.

[9] A wire harness including;

the exterior member for a wire harness according to any one of [6] to [8]; and

an electrically conductive path (high-voltage electrically conductive path 125) that is inserted into the exterior member.

The invention has been described above in detail with reference to specific embodiments. However, it will be understood by those skilled in the art that various changes and modifications are possible within a scope which does not depart from the gist of the present invention.

### INDUSTRIAL APPLICABILITY

According to the invention, large equipment or a plurality of molds are not needed and dimensional change can be easily achieved. Therefore, the invention is useful for an exterior member and a wire harness provided with the exterior member.

### Reference Signs List

1, 101 hybrid car

2, 102 engine

3, 103 motor unit

4, 104 inverter unit

5, 105 battery

6, 106 engine room

7, 107 automobile rear portion

8, 9, 108, 109 wire harness

10, 110 intermediate portion

11, 111 vehicle underfloor portion

12, 112 junction block

13, 113 harness terminal

14, 114 shield connector

15, 115 wire harness

16, 116 low-voltage battery

17, 117 automobile front portion

18, 118 auxiliary machine

19, 119 harness main body

20 clamp

21 clamp (pipe fixing member)

22, 23, 122, 123 water stopping member

24, 124 exterior member

25, 125 high-voltage electrically conductive path (electrically conductive path)

26, 126 harness main body

27, 127 connector

28, 128 corrugate tube

29, 30 straight pipe

31 to 34, 131 to 134 flexible portion

35, 36, 135, 136 fixed portion

37, 139 fixation target

38, 39 portion (other portion)

40, 145 high-voltage cable

41, 146 shield member

42, 147 conductor

43, 148 insulator

120 fixing member

129, 130 fixing portion

137 bellows concave portion

138 bellows convex portion

140, 141 portion (other than flexible portion)

142 bellows fitting portion

143 bent plate portion

144 end portion

151 exterior member

152 fixing portion

153 rod-shaped portion

161 exterior member

What is claimed is:

1. An exterior member for a wire harness, which is formed in a tubular shape, comprising;
a flexible portion which is bendable; and
a fixed portion which is fixed in a straight shape,
wherein the flexible portion is formed by a desired portion in an axial direction of a corrugate tube, and
wherein the fixed portion is formed by a portion other than the desired portion of the corrugate tube, and a straight pipe which covers an inside or an outside of the portion other than the desired portion.

2. The exterior member for the wire harness according to claim 1,
wherein the straight pipe covers an outside of the corrugate tube so that the fixed portion is formed.

3. The exterior member for the wire harness according to claim 2,
wherein pipe fixing members are respectively provided at both ends of the straight pipes.

4. The exterior member for the wire harness according to claim 3,
wherein the corrugate tube is provided with clamps as the pipe fixing members.

5. A wire harness comprising;
the exterior member for the wire harness according claim 1; and
an electrically conductive path which is inserted into the exterior member.

6. An exterior member for a wire harness, which is formed in a tubular shape, comprising:
a flexible portion which is bendable; and
a fixed portion which is fixed in a straight shape,
wherein the flexible portion is formed by a desired portion in an axial direction of a corrugate tube,
wherein the fixed portion is formed by a fixing portion which is attached and fixed to a portion other than the desired portion of the corrugate tube,
wherein the fixing portion includes a plurality of bellows fitting portions which are arranged along the axial direction and which are externally fitted onto a plurality of bellows concave portions of the corrugate tube, and
wherein each of the plurality of the bellows fitting portions is formed into a bent rib-like shape in which a length in a circumference direction is equal to or greater than half of an outer circumference of one of the bellows concave portions.

7. The exterior member for the wire harness according claim 6,
wherein the fixing portion includes a bent plate portion or a rod-shaped portion which extends along the axial direction and which is integrally formed with the plurality of the bellows fitting portions.

8. The exterior member for the wire harness according to claim 6,
wherein each of the plurality of the bellows fitting portions has elasticity and a diameter of each of the plurality of the bellows is formed to be smaller than a diameter of one of the bellows concave portions.

9. A wire harness comprising;
the exterior member for the wire harness according claim 6; and
an electrically conductive path which is inserted into the exterior member.
